(19) United States
(12) Patent Application Publication
(10) Pub. No.: US 2008/0094357 A1
(43) Pub. Date: Apr. 24, 2008

(54) DESIGN FOR THE MOUSE FOR ANY PORTABLE DEVICE

(75) Inventor: Sacchindrakumar Gopikisan Kalantri, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/551,528

(22) Filed: Oct. 20, 2006

(51) Int. Cl. G09G 5/08

(52) U.S. Cl. 345/158

(57) ABSTRACT

Systems and methodologies are described that facilitate navigating data associated with a portable device. According to various aspects, systems and/or methods are described that facilitate incorporating a motion input on at least one side of a portable device, the portable device includes a casing with a front, a back, and at least two sides associated therewith, a top and a bottom. Such systems and/or methods may further facilitate utilizing the motion input to employ four or more degrees of freedom for data entry.

### BACKGROUND

I. Field

The following description relates generally to wireless communications, and more particularly to providing multiple degrees of freedom for motion input associated with a portable device.

II. Background

Wireless communication systems are widely deployed to provide various types of communication; for instance, voice and/or data may be provided via such wireless communication systems. A typical wireless communication system, or network, can provide multiple users access to one or more shared resources. For instance, a system may use a variety of multiple access techniques such as Frequency Division Multiplexing (FDM), Time Division Multiplexing (TDM), Code Division Multiplexing (CDM), and others.

Common wireless communication systems employ one or more base stations that provide a coverage area. A typical base station can transmit multiple data streams for broadcast, multicast and/or unicast services, wherein a data stream may be a stream of data that can be of independent reception interest to a user device. A user device within the coverage area of such base station can be employed to receive one, more than one, or all the data streams carried by the composite stream. Likewise, a user device can transmit data to the base station or another user device.

Portable devices are increasing in technological ability wherein such devices can provide a plurality of functionality within a limited device-space. Portable devices can be, but not limited to, cell phones, PDA, pagers, tablets, messenger devices, mobile communication devices, pocket translators, bar code scanners, smart phones, scanners, hand-held devices, portable handheld scanners, etc. Although each device employs a specific function for a user, devices have been developing to allow overlapping functionality in order to appeal to consumer needs. In other words, mobile communication devices have incorporated a plurality of features and/or applications such that the devices have invaded one another's functionality. In particular, as portable devices become more powerful (e.g., enhanced functionality, improved and/or additional features, etc.), some traditional work station (e.g., desktop computers, machines, and the like) are extending into the portable device realm. As a result, portable devices have incorporated a variety of techniques and/or methods for inputting information. Portable devices facilitate entering information employing devices such as, but not limited to, buttons, keys, keyboards, keypads, touch-screens, speakers, stylus' (e.g., wands), writing pads, etc. Therefore, consumer need for efficient data entry techniques is apparent based on the features and/or applications abilities hinge on such interaction.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to more detailed description that is presented later.

In accordance with one or more embodiments and corresponding disclosure thereof, various aspects are described in connection with facilitating data entry and/or navigation of data within a portable device. According to various aspects, systems and/or methods are described that facilitate incorporating and/or integrating a motion input on at least one side of a portable device to enable N degrees of freedom, where N is a positive integer. The motion input can be any suitable mechanism to detect movement such as a roller-ball, a trackball, a touchpad, etc. In addition, such motion input can be positioned on at least one side to coincide with a digit upon holding such hand-held device in the palm of a hand. Such systems and/or methods may further allow the motion input to provide a keypad input functionality. Still further, such systems and/or methods may employ activation and/or de-activation mechanism to reduce accidental data entry and/or navigation.

According to related aspects, a method that facilitates data entry is described herein. The method may include incorporating a motion input on at least one side of a portable device, the portable device includes a casing with a front, a back, and at least two sides associated therewith, a top and a bottom. Further the method may include utilizing the motion input to employ four or more degrees of freedom for data entry.

Another aspect relates to a portable apparatus that may include a memory that retains instructions related to coordinating data associated with a motion input for navigation on a display, the motion input is integrated within the portable apparatus on at least one side interconnected between a back and a front related thereto. Further, a processor may evaluate the instructions to utilize data associated with the motion input.

Yet another aspect relates to a portable apparatus that facilitates data navigation. The portable apparatus may include means for displaying data within a portable device on a display, the display is enclosed within a casing associated with the portable device. The portable apparatus may further include means for integrating a motion input on at least one side associated with the portable device. Moreover, the portable apparatus may include means for implementing data entry corresponding to the displayed data with at least four or more degrees of freedom utilizing the motion input.

Still another aspect relates to a machine-readable medium having stored thereon machine-executable instructions for collecting motion data from a motion input incorporated on at least one side associated with a portable device, the portable device includes a front, a back, at least two sides associated therewith, a top, and a bottom, and utilizing the motion input to employ four or more degrees of freedom for data entry related to the portable device.

In accordance with another aspect, a processor is described herein, wherein the processor may execute instructions for displaying data within a portable device on a front portion of the portable device. Further, the processor may execute instructions for collecting motion data from a motion input on at least one side associated with the portable, the motion input employs four or more degrees of freedom. Additionally, the processor may execute instructions for utilizing motion data to manipulate the displayed data.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a hand-held device that incorporates a motion input that facilitates providing multiple degrees of freedom for data entry.

FIG. 3 is an illustration of a hand-held device that incorporates a touchpad motion input that facilitates providing four or more degrees of freedom for data entry.

FIG. 4 is an illustration of a hand-held apparatus that can be employed to mitigate restricted degrees of motion for data entry via utilizing an integrated motion input on the hand-held apparatus.

FIG. 5 is an illustration of a methodology that facilitates employing four or more degrees of freedom related to data entry for a hand-held device.

FIG. 6 is an illustration of a methodology that facilitates incorporating a motion input on a hand-held device for manipulation of displayed data.

FIG. 7 is an illustration of a methodology that facilitates minimizing accidental data entry on a hand-held device utilizing the motion input.

FIG. 8 is an illustration of a user device that facilitates monitoring and/or providing feedback in connection with broadcast and/or multicast transmission(s).

FIG. 9 is an illustration of a wireless network environment that can be employed in conjunction with the various systems and methods described herein.

FIG. 10 is an illustration of a system that facilitates employing four or more degrees of freedom related to data entry for a hand-held device.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “module,” “device,” “apparatus,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device can be a module. One or more module can reside within a process and/or thread of execution and a module may be localized on one computer and/or distributed between two or more computers. In addition, these modules can execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

Furthermore, various embodiments are described herein in connection with a subscriber station. A subscriber station can also be called a system, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

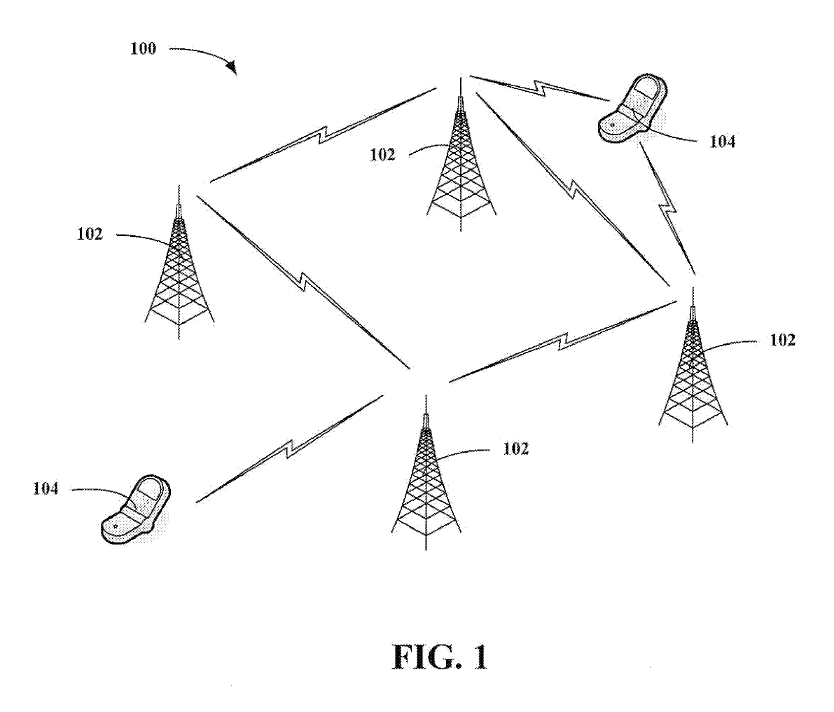

Referring now to FIG. 1, a wireless communication system 100 is illustrated in accordance with various embodiments presented herein. System 100 can comprise one or more base stations 102 (e.g., access points) in one or more sectors that receive, transmit, repeat, etc., wireless communication signals to each other and/or to one or more mobile devices 104 and/or portable devices. Each base station 102 can comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Mobile devices 104 can be, for example, cellular phones, portable devices, smart phones, laptops, handheld communication devices, handheld computing devices, satellite radios, global positioning systems, PDAs, and/or any other suitable device for communicating over wireless communication system 100.

Such mobile devices 104 can include various data inputs to enable device-specific features and/or any other suitable data transmission associated with the base stations 102, the mobile device 104, a disparate mobile device 104, etc. In particular, the mobile device 104 can include a motion input that can employ four or more degrees of freedom for data entry and/or motion entry. Generally, the motion input can be incorporated into any suitable mobile device 104 such as, but not limited to, a cellular phone, a smartphone, portable device, a text messenger, a hand-held device, a mini-computer, a portable digital assistant (PDA), a hand-held computing device, a satellite radio, a satellite device, a global positioning system (GPS), a GPS device, and/or any other suitable device that can receive data via an input.

Specifically, the motion input can be integrated into at least one side on the mobile device 104, wherein the mobile device 104 can have a front, a back, and at least two sides associated therewith. In one example, the motion input can be substantially similar to at least one of a mouse input device, a trackball, a roller-ball, and/or a touchpad. For instance, a mobile communication device can employ a trackball embedded on at least one side. The user can grasp the mobile communication device in a hand, wherein at least one digit can utilize the embedded trackball (e.g., motion input) to enter data with four or more degrees of freedom. Thus, a left-handed user can maneuver a cursor on a mobile device display utilizing the motion input on the left side of the mobile device 104 with their left thumb.

Conventionally, such mobile devices 104 and/or hand-held devices are limited in providing degrees of freedom for data entry. Implementing an external mouse and/or trackball device to the mobile device limits the use of such device and, even more so, defeats the purpose of providing mobility and ease of use. Moreover, typical inputs for mobile devices 104 and/or portable devices are limited to directional inputs such as up, down, left, and right. Thus, the motion input provide superior functionality with allowing data entry in N degrees of freedom, where N is a positive integer. In other words, the data entry utilizing the incorporated motion input can allow analog-like data entry and/or control for the mobile device 104 and/or portable device.

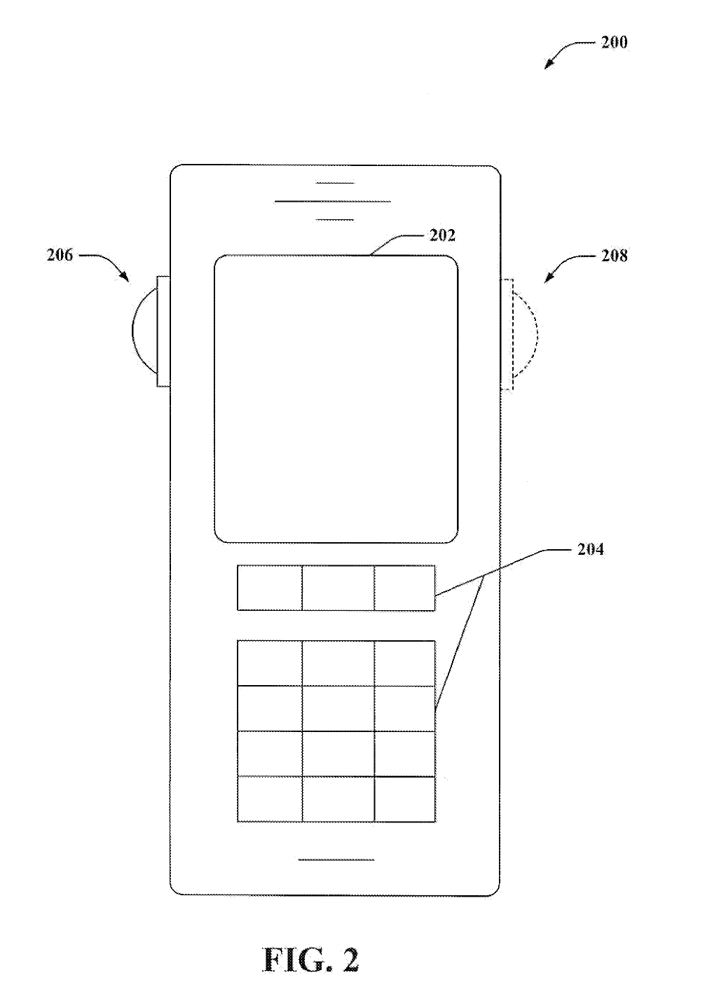

With reference to FIG. 2, illustrated is a portable device 200 that incorporates a motion input that facilitates providing multiple degrees of freedom for data entry. The portable device 200 can include a casing that has a front, a back, at least two sides in-between the front and back, a top, and a bottom. It is to be appreciated that the portable device 200 can be, for instance, a cellular phone, a smartphone, a text messenger, a hand-held device, a mini-computer, a portable digital assistant (PDA), a hand-held computing device, a satellite radio, a satellite device, a global positioning system (GPS), a GPS device, and/or any other suitable device that can receive data via an input. The portable device 200 can be any suitable device to which an input can be utilized to provide data manipulation and/or navigation. For instance, the portable device 200 can be a device attached to a belt, a holder, and the like. In another example, the portable device 200 can be attached to a user. The portable device 200 is depicted with the front portion having a display 202, wherein the display 202 can be utilized to illustrate any data (e.g., graphical data, a portion of a graphic, etc.). In one example, the display can utilize a cursor graphic that can facilitate data selection and/or input. The casing associated with the portable device 200 can be any suitable material such as, but not limited to, plastic, aluminum, magnesium, metal, and the like. Furthermore, the portable device 200 can include any suitable number of key inputs 204. As illustrated, the portable device 200 includes an upper portion of key inputs and a lower portion of key inputs. For instance, the upper portion of key inputs 204 can provide device functionality such as data selection/activation, power on, power off, and the like. In another example, the lower portion of key inputs 204 can provide inputs for characters, numbers, symbols, etc. and/or can resemble a QWERTY alphanumeric keypad.

On at least one side of the casing, a motion input 206 can be embedded and/or incorporated into the portable device 200. It is to be appreciated that the motion input 206 can be a trackball, a roller-ball, a touchpad, a motion-detection device, and/or any other suitable device that can detect and/or collect data associated with motion. The motion input 206 can be at least partially protruding from an aperture on the side of the portable device 200. As depicted, the motion input 206 can be a spherical object, wherein at least a portion of such spherical object is protruding from the side to allow contact with a digit associated with a user for motion detection. However, it is also to be appreciated that the motion input 206 can be a touchpad (e.g., discussed infra).

The motion input 206 can be positioned on the portable device 200 such that upon the grasping and/or holding of such device, the motion input 206 can detect and/or collect data associated with at least one digit (e.g., thumb, finger, etc.). A user can hold the portable device 200 with the back portion on the palm of a hand with four fingers on one side and the thumb on the other side. Thus, the positioning of the motion input 206 can correlate with any of these digits on either side of the device (e.g., an additional or optional motion input is shown at 208). Although such configuration and/or placement of the motion input 206 can vary based on user-preferences, the thumb is an extremely versatile digit and placement of the motion input 206 can coincide therewith. Moreover, based on whether the device is for a left-handed user and/or a right-handed user, the motion input can be placed on the respective side (e.g., for a left-handed user, the motion input 206 will be on the left side while for a right-handed user, the motion input 206 will be on the right side). In addition, the portable device 200 can include more than one motion input 206 for ambidextrous users and/or to allow the portable device 200 to be utilized by either user (e.g., left-handed and/or right-handed). In other words, the portable device 200 can include a plurality of motion inputs 206, wherein each motion input 206 can have a respective functionality associated therewith. Moreover, the motion input 206 can also be used (in addition to navigating data) to provide input such as clicks that indicate user selection, transfer of control, or any other suitable action utilizing a motion input 206. For instance, a user can depress the motion input 206 (e.g., ball/button, trackball, a roller-ball, a touchpad, a motion-detection device, and/or any other suitable device that can detect and/or collect data associated with motion, etc.) that may activate a switch to indicate the click.

For example, the portable device can be a cellular phone that includes a camera, calendar, address book, Internet browser, media player, audio recorder, etc. By incorporating the motion input 206 into the cellular phone, data selection, navigation, and/or device functionality is greatly enhanced and optimized. The motion input 206 can provide N degrees of freedom for motion input, where N is a positive integer. For example, the cellular phone may include a cursor that can be navigated in a diagonal direction with the motion input 206 which cannot be implemented with conventional data inputs on portable devices. Moreover, the motion input 206 can provide analog-like input to navigate data related to the cellular phone, which bodes extremely well for navigating data (e.g., utilizing a cursor, etc.) with a device providing numerous functions. Thus, a user can easily select a particular application and/or function (e.g., camera, calendar, address book, Internet browser, media player, audio recorder, etc.) and/or activate such data related thereto, and so on and so forth.

In another example, the motion input 206 can also provide a key input functionality, wherein the motion input 206 can be depressed into the side of the portable device 200 (e.g., substantially similar to a button input). In the example with the motion input 206 being a roller-ball and/or trackball, the spherical object can be depressed inwards toward the side of the portable device 200 to replicate a button being depressed. Thus, the motion input 206 can navigate and/or select data associated with the portable device 200. In the example with the motion input 206 being a touchpad, the touchpad can detect a tap and/or quick touching that replicates a clicking on a mouse. Such detection of tapping and/or quick touching can be utilized to select data as well.

As still another example, the motion input 206 can be activated and/or de-activated to reduce the chances of accidental contact and/or data entry/navigation. For instance, any activation and/or de-activation technique can be utilized such as a button, a key, a voice command, a switch, a password, a fingerprint, a double-click, a sequence of inputs (e.g., particular motions on the motion input), retinal scan, etc. In other words, based on the motion input allowing data entry and/or navigation for the portable device, it is to be appreciated that any suitable technique and/or mechanism can be employed to reduce accidental contact and ensure data collection from the motion input is intentional.

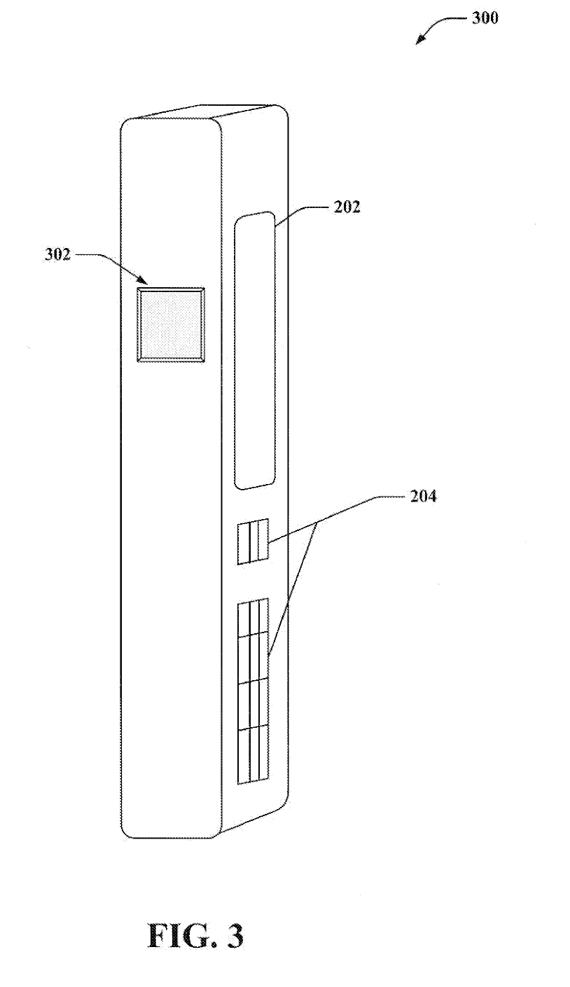

Turning to FIG. 3, illustrated is a portable device 300 that incorporates a touchpad motion input that facilitates providing four or more degrees of freedom for data entry. The portable device can have a casing (e.g., enclosure, and the like) that includes a front, a back, at least two sides in-between the front and back, a top, and a bottom. The portable device 200 can be, for instance, a cellular phone, a smartphone, a text messenger, a hand-held device, a mini-computer, a portable digital assistant (PDA), a hand-held computing device, a satellite radio, a satellite device, a global positioning system (GPS), a GPS device, and/or any other suitable device that can receive data via an input. The portable device 300 can be any suitable device to which an input can be utilized to provide data manipulation and/or navigation. For instance, the portable device 300 can be a device attached to a disparate object such as a belt, a holder, and the like. In another example, the portable device 300 can be attached to a user. Furthermore, the portable device 300 can be substantially similar to the portable device 200 depicted in FIG. 2.

On at least one side associated with the portable device 300 can be a touchpad motion input 302 that can be incorporated therewith. The touchpad motion input 302 can provide the detection and/or collection of motion input/data from, for instance, a user. The touchpad motion input 302 can be positioned on the portable device 300 in such a manner to easily coincide with a digit associated with a user's hand while grasping and/or holding such device. In particular, the portable device 300 can be typically held in the palm of a hand with four fingers on one side and a thumb on the opposite side. It is to be appreciated that the touchpad motion input 302 can be on any location on the side of the portable device 300 that corresponds to a digit (e.g., finger, thumb, etc.). Such configuration and/or placement of the touchpad motion input 302 can vary based on user-preferences, yet the thumb is an extremely versatile digit and placement of the touchpad motion input 302 can coincide therewith. Furthermore, the touchpad motion input 300 can be sunk into the side to signify its presence, raised from the side to signify its presence, and/or flush with the side to blend into the side of the portable device 300. Although the touchpad motion input 302 is illustrated as a rectangle, it is to be appreciated that any suitable size and/or shape can be utilized to implement the touchpad motion input 302.

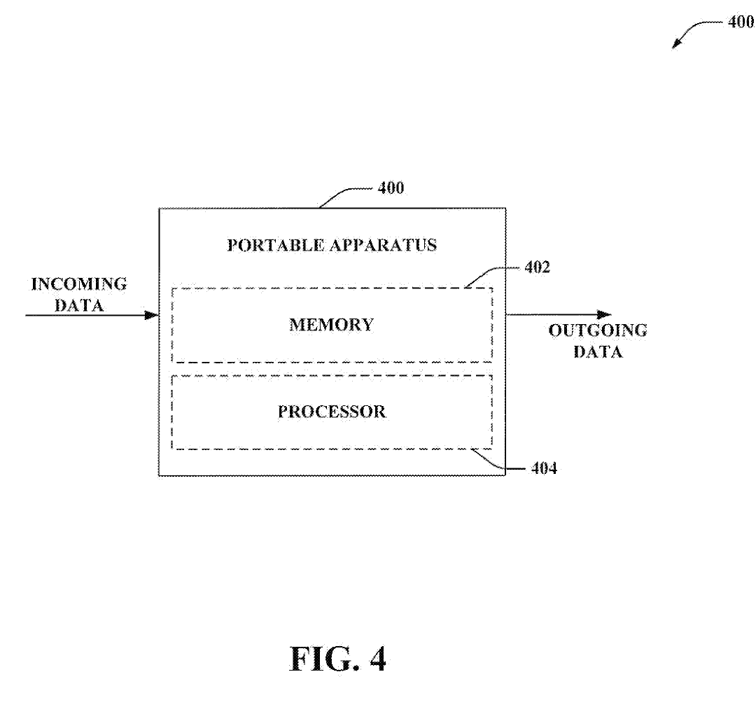

Turning to FIG. 4, illustrated is a portable apparatus 400 that can be employed to mitigate restricted degrees of motion for data entry via utilizing an integrated motion input on the portable apparatus. Portable apparatus can be any portable device that can employ data navigation such as, but not limited to, a cellular phone, a smartphone, a text messenger, a hand-held device, a mini-computer, a portable digital assistant (PDA), a hand-held computing device, a satellite radio, a satellite device, a global positioning system (GPS), a GPS device, and the like. The portable apparatus 400 can include memory 402 that can retain information associated with at least one of a motion input, a touchpad motion input, and/or data collected via a motion input and/or instructions related to coordinating motion input for navigation on a display. Additionally, portable apparatus 400 may include a processor 404 that can execute such instructions within memory 402 and/or utilize at least one of the motion input, the touchpad motion input, and/or data collected via the motion input.

For example, the memory 402 can include instructions on collecting data from the motion input and/or touchpad motion input, wherein such instructions can be executed by the processor 404 to allow for data navigation associated with the portable apparatus 400. The data navigation can be implemented such that an analog-like input can be provided by the motion input to allow N degrees of freedom, where N is a positive integer. Moreover, the motion input can be utilized to activate and/or employ particular functions and/or features associated with the portable apparatus 400.

In another example, the instructions within the memory 402 can relate to coordinating motion input data collected with navigation within a display on the portable apparatus 400. Thus, a particular movement (e.g., motion input data) can be detected, collected, and utilized from the motion input to correlate with data displayed on the portable apparatus 400. For instance, a movement in the Y direction with the motion input can correlate to a movement in the Y direction on the display. In still another example, the memory 402 can store instructions associated with settings, user profiles, configurations, scaling features (e.g., an amount of movement for the motion input translates to particular amount of movement on the display, etc.), etc., wherein the processor 404 can retrieve and execute such instructions to allow the implementation of analog-like navigation with the motion input.

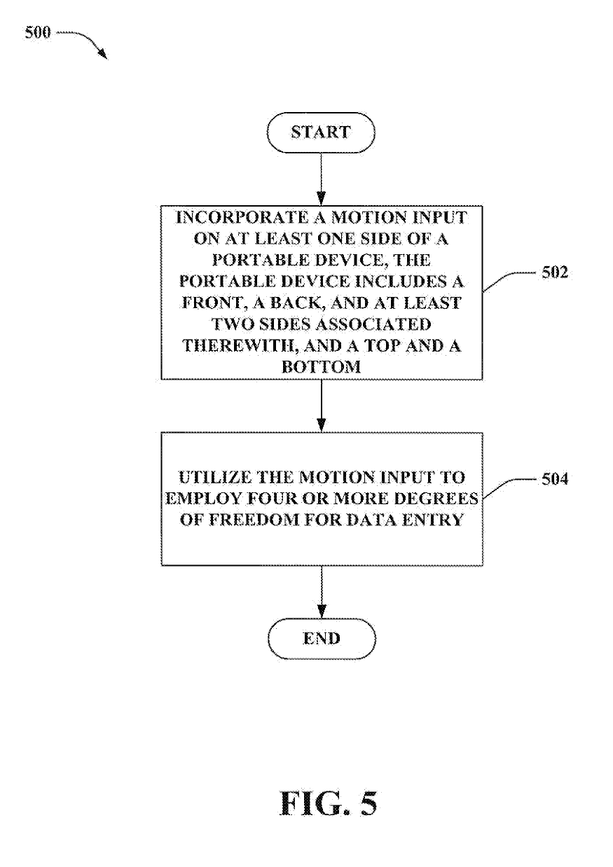

Referring to FIGS. 5-7, methodologies relating to incorporating a motion input with a portable device for data entry are illustrated. For example, methodologies can relate to implementing a motion input for data entry associated with a portable device. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Now referring to FIG. 5, a methodology 500 is illustrated that facilitates employing four or more degrees of freedom related to data entry for a portable device. At reference numeral 502, a motion input can be incorporated on at least one side of a portable device, wherein the portable device can include a front, a back, at least two sides associated therewith, a top, and a bottom. The portable device can be, but is not limited to, a cellular phone, a smartphone, a text messenger, a hand-held device, a mini-computer, a portable digital assistant (PDA), a hand-held computing device, a satellite radio, a satellite device, a global positioning system (GPS), a GPS device, and/or any other suitable device that can receive data via an input. The portable device can be any suitable device to which an input can be utilized to provide data manipulation and/or navigation. For instance, the portable device can be a device attached to a belt, a holder, and the like. In another example, the portable device can be attached to a user.

On at least one side of the casing, a motion input can be embedded and/or incorporated into the portable device. It is to be appreciated that the motion input can be a trackball, a roller-ball, a touchpad, a motion-detection device, and/or any other suitable device that can detect and/or collect data associated with motion. In one example, the motion input can be at least partially protruding (e.g., partially embedded into the device) from an aperture on the side of the portable device. In another example, the motion input can be a spherical object substantially similar to a trackball, wherein at least a portion of such spherical object is protruding from the side to allow contact with a digit associated with a user for motion detection. In another instance, the motion input can be a touchpad, wherein the touchpad can be a surface that detects motion based on contact (e.g., utilizing inductance, heat, pressure, etc.). In one example, the touchpad motion input can be slightly raised from the side of the device (e.g., to signify its presence), indented into the side of the device (e.g., to signify its presence, protect from damage, etc.), and/or flush with the side of the device.

At reference numeral 504, the motion input can be utilized to employ four or more degrees of freedom for data entry with the portable device. For instance, the motion input can collect motion data utilizing a trackball, a roller-ball, a touchpad, etc., wherein such collection allows data entry and/or navigation on a display in any direction associated therewith. In other words, data on the display, for instance a cursor, can be manipulated and/or navigated in any direction related to the display such as (e.g., utilizing the center of the display as a reference point for this example) up, down, left, right, diagonal up-right, diagonal down-left, diagonal up-left, diagonal down-right, 72 degrees, −187 degrees, 350 degrees, etc.

Furthermore, the motion input can be positioned in a location on the side of the device that optimizes access thereto to facilitate detecting movement. For instance, the motion input can be employed by a user with a digit (e.g., thumb, finger, etc.), wherein the placement of the motion input can coincide with such digit upon holding and/or grasping the portable device. In particular, the portable device can be within the palm of a hand with four fingers on one side and the thumb on the opposite side. It is to be appreciated that the motion input can correlate to at least one digit on either side of the portable device, yet (based on the thumb being a versatile digit) the position that relates to the thumb can be beneficial.

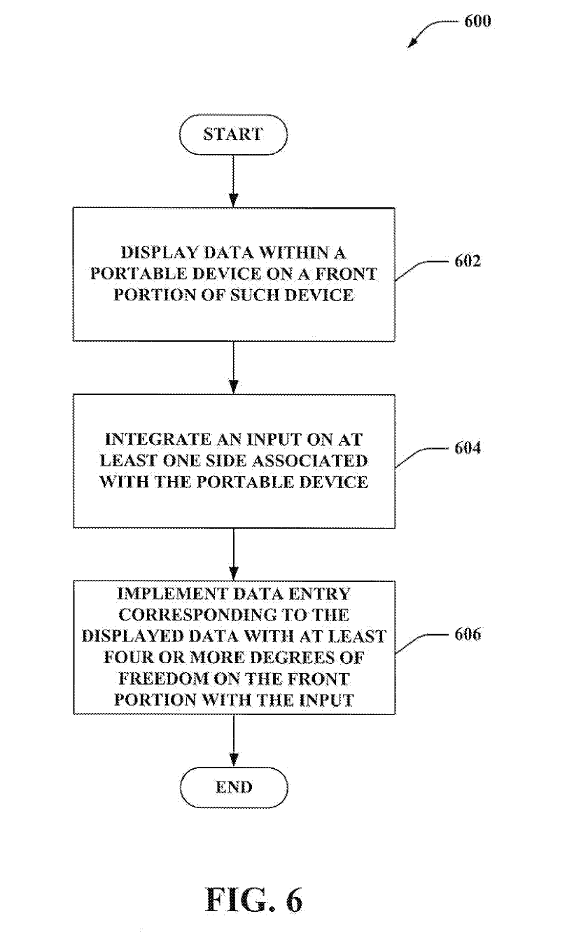

Turning to FIG. 6, illustrated is a methodology 600 that facilitates incorporating a motion input on a portable device for manipulation of displayed data. At reference numeral 602, data within a portable device can be displayed on a front portion of such device. The display can be any suitable display that can be utilized by the portable device, wherein the portable device can be, for example, a cellular phone, a smartphone, a text messenger, a hand-held device, a mini-computer, a portable digital assistant (PDA), a hand-held computing device, a satellite radio, a satellite device, a global positioning system (GPS), a GPS device, and/or any other suitable device that can receive data via an input. At reference numeral 604, a motion input can be integrated on at least one side associated with the portable device. The portable device can have a front, a back, at least two sides associated therewith, a top, and a bottom. The motion input can be incorporated into the portable device on a side, wherein the position coincides with a digit when a hand is grasping and/or holding such portable device. For instance, the motion input can be on a right side of the portable to coincide with an index finger when the device is held in the palm of a left hand.

At reference numeral 606, data entry can be implemented that corresponds to the displayed data with at least four degrees of freedom utilizing the motion input. The motion input can provide at least four degrees of freedom when navigating data associated with the display on the portable device. In other words, data associated with the display can be manipulated in any direction (using the display as a reference point). Thus, a user can maneuver the motion input to a diagonal direction, wherein a cursor, for example, can also maneuver in a diagonal direction to facilitate data navigation and/or employment of the portable device.

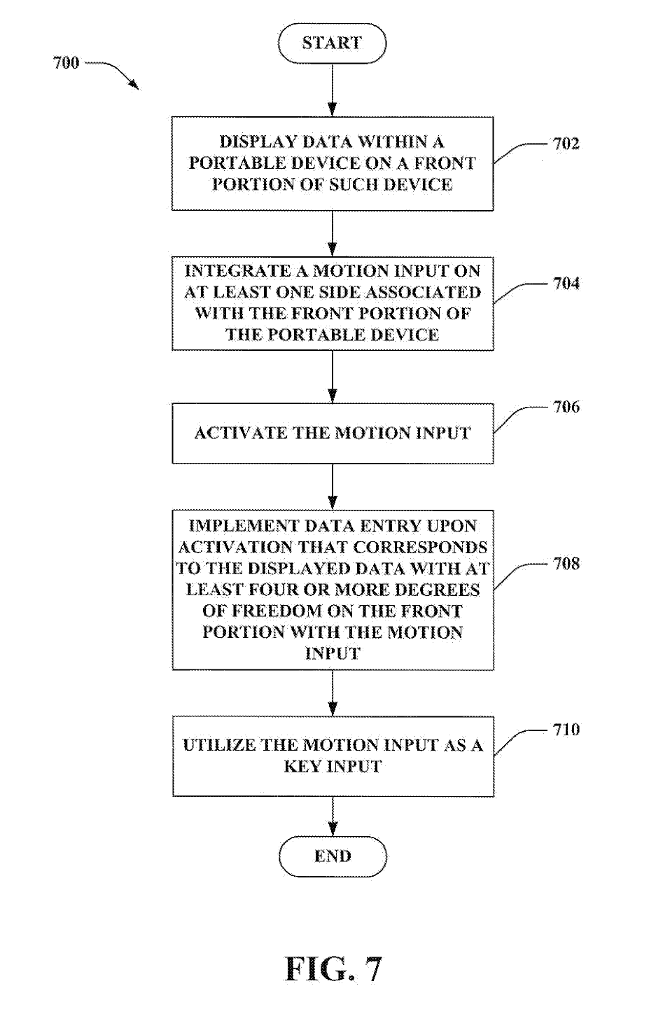

Turning to FIG. 7, illustrated is a methodology 700 that facilitates minimizing accidental data entry on a portable device utilizing the motion input. At reference numeral 702, data can be displayed within a portable device on a front portion of such device. The front portion of the portable can include any suitable display such as, but not limited to, a monitor, an LCD, a plasma screen, a dot matrix screen, a CRT, a monitor, a television, any display capable of displaying at least one pixel, etc. Continuing at reference numeral 704, a motion input can be integrated on at least one side associated with the front portion of the portable device. The portable device can include a front, a back, at least two sides interconnected therewith, a top, and a bottom. The motion input can be incorporated therewith, wherein the motion input can be, but is not limited to being, a trackball, a roller-ball, a touchpad, a motion-detection device, and/or any other suitable device that can detect and/or collect data associated with motion.

At reference numeral 706, the motion input can be activated. The activation and/or de-activation can reduce the chances of accidental contact and/or data entry/navigation associated with the portable device. For instant, any activation and/or de-activation technique can be utilized such as a button, a key, a voice command, a switch, a password, a fingerprint, a double-click, a sequence of inputs (e.g., particular motions on the motion input), retinal scan, etc. In other words, based on the motion input allowing the data entry and/or navigation for the portable device, it is to be appreciated that any suitable technique and/or mechanism can be employed to reduce accidental contact and ensure data collection from the motion input is intentional. In one example, the activation can be the depressing of a particular key input to allow the motion input to start movement-related data collection which can be used to navigate data associated with the display.

At reference numeral 708, the data entry can be implemented upon the activation that corresponds to the displayed data with at least four degrees of freedom on the front portion with the motion input. For instance, the motion input can collect motion data, wherein such collection allows data entry and/or navigation on a display in any direction associated therewith. In other words, data on the display, for instance a cursor, can be manipulated and/or navigated in any direction related to the display such as (e.g., utilizing the center of the display as a reference point for this example) up, down, left, right, diagonal up-right, diagonal down-left, diagonal up-left, diagonal down-right, 72 degrees, −187 degrees, 350 degrees, etc.

At reference numeral 710, the motion input can be utilized as a key input. In particular, the motion input can utilize a key input functionality, wherein the motion input can be depressed into the side of the portable device (e.g., substantially similar to a button input). In the example with the motion input being a roller-ball and/or trackball, the spherical object can be depressed inwards toward the side of the portable device to replicate a button being depressed. Thus, the motion input can navigate and/or select data associated with the portable device. In the example with the motion input being a touchpad, the touchpad can detect a tap and/or quick touching that replicates a clicking on a mouse. Such detection of tapping and/or quick touching can be utilized to select data as well.

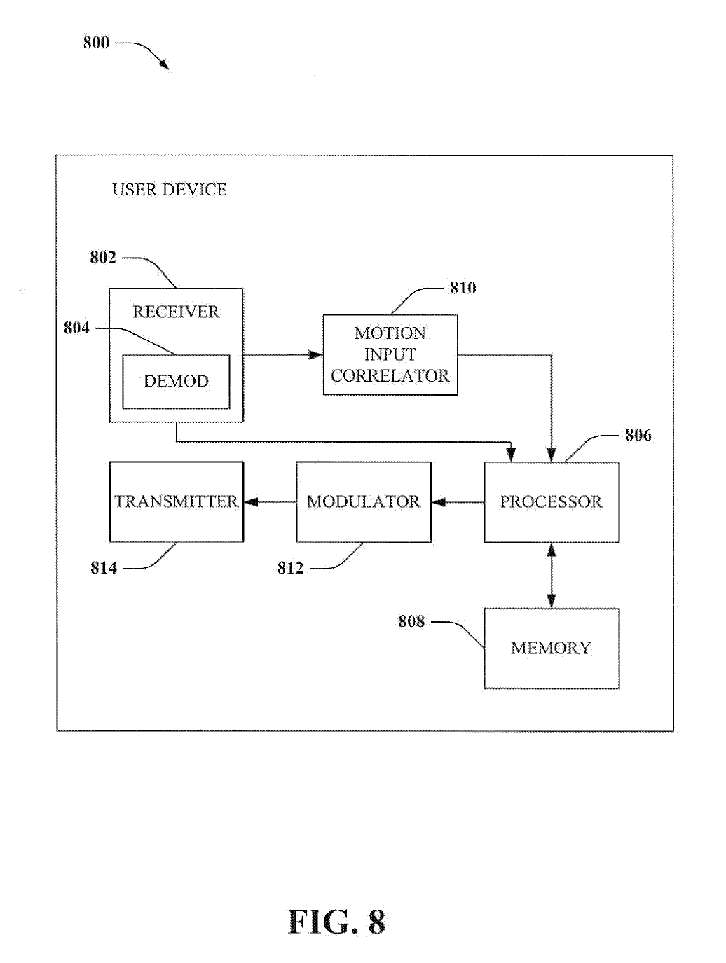

FIG. 8 is an illustration of a user device 800 (e.g., portable device, portable digital assistant (PDA), a cellular device, a mobile communication device, a smartphone, a messenger device, etc.) that facilitates communicating and/or manipulating data. User device 800 comprises a receiver 802 that receives a signal from, for instance, a receive antenna (not shown), and performs typical actions thereon (e.g., filters, amplifies, downconverts, etc.) the received signal and digitizes the conditional signal to obtain samples. Receiver 802 can be, for example, an MMSE receiver, and can comprise a demodulator 804 that can demodulate received symbols and provide them to a processor 806 for channel estimation. Processor 806 can be a processor dedicated to analyzing information received by receiver 802 and/or generating information for transmission by a transmitter 816, a processor that controls one or more components of user device 800, and/or a processor that both analyzes information received by receiver 802, generates information for transmission by transmitter 816, and controls one or more components of user device 800.

User device 800 can additionally comprise memory 808 that is operatively coupled to processor 806 and that may store data to be transmitted, received data, information related to available channels, data associated with analyzed signal and/or interference strength, information related to an assigned channel, power, rate, or the like, and any other suitable information for estimating a channel and communicating via the channel. Memory 808 can additionally store protocols and/or algorithms associated with estimating and/or utilizing a channel (e.g., performance based, capacity based, etc.).

It will be appreciated that the data store (e.g., memory 808) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 808 of the subject systems and methods in intended to comprise, without being limited to, these and any other suitable types of memory. In addition, it is to be appreciated that the data store 808 can be a server, a database, a hard drive, and the like.

Receiver 802 is further operatively coupled to a motion input correlator 810 that provides data correlation associated with collected motion data via a motion input incorporated into a side of the user device, wherein user device 800 includes a front, a back, at least one side interconnected there between, a top and a bottom. The motion input correlator 810 can translate data related to the motion input into navigation and/or data entry for the user device 800. It is to be appreciated that the motion input correlator 810 can allow the movement and/or analog-like data associated with the motion input to be utilized with the user device for interacting with any data associated therewith. In one example, the motion input correlator may collect data from a motion input (not shown and incorporated physically on a side of the user device) and provide such data to the processor 806 to execute instructions related to navigation and/or the motion input.

User device 800 still further comprises a modulator 812 and a transmitter 814 that transmits the signal to, for instance, a base station, another use device, a NOC, a remote agent, etc. Although depicted as being separate from the processor 806, it is to be appreciated that motion input correlator 810 and/or modulator 812 may be part of processor 806 or a number of processors (not shown).

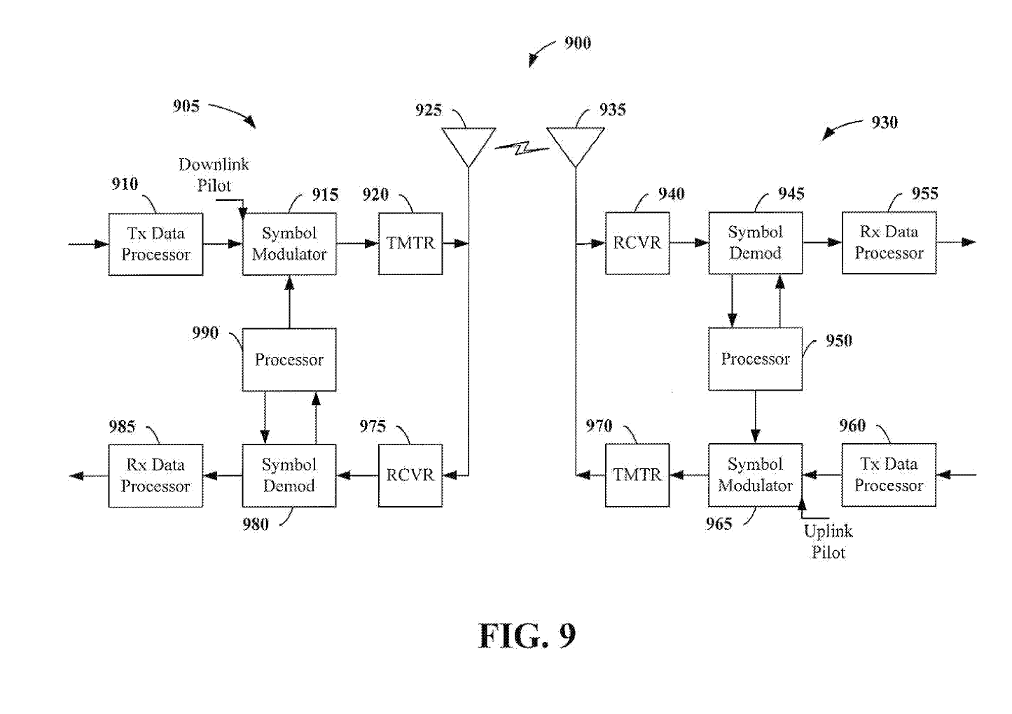

FIG. 9 shows an exemplary wireless communication system 900. The wireless communication system 900 depicts one access point (e.g., base station) and one terminal for sake of brevity. However, it is to be appreciated that the system can include more than one access point and/or more than one terminal, wherein additional access points and/or terminals can be substantially similar or different for the exemplary access point and terminal described below. In addition, it is to be appreciated that the access point and/or the terminal can employ the systems (FIGS. 1, 9, 10), apparatuses and devices (FIGS. 2-4, 8), and/or methods (FIGS. 5-7) described herein to facilitate wireless communication there between.

Referring now to FIG. 9, on a downlink, at access point 905, a transmit (TX) data processor 910 receives, formats, codes, interleaves, and modulates (or symbol maps) traffic data and provides modulation symbols (“data symbols”). A symbol modulator 915 receives and processes the data symbols and pilot symbols and provides a stream of symbols. A symbol modulator 915 multiplexes data and pilot symbols and provides them to a transmitter unit (TMTR) 920. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 920 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 925 to the terminals. At terminal 930, an antenna 935 receives the downlink signal and provides a received signal to a receiver unit (RCVR) 940. Receiver unit 940 conditions (e.g., filters, amplifies, and frequency downconverts) the received signal and digitizes the conditioned signal to obtain samples. A symbol demodulator 945 demodulates and provides received pilot symbols to a processor 950 for channel estimation. Symbol demodulator 945 further receives a frequency response estimate for the downlink from processor 950, performs data demodulation on the received data symbols to obtain data symbol estimates (which are estimates of the transmitted data symbols), and provides the data symbol estimates to an RX data processor 955, which demodulates (i.e., symbol demaps), deinterleaves, and decodes the data symbol estimates to recover the transmitted traffic data. The processing by symbol demodulator 945 and RX data processor 955 is complementary to the processing by symbol modulator 915 and TX data processor 910, respectively, at access point 905.

On the uplink, a TX data processor 960 processes traffic data and provides data symbols. A symbol modulator 965 receives and multiplexes the data symbols with pilot symbols, performs modulation, and provides a stream of symbols. A transmitter unit 970 then receives and processes the stream of symbols to generate an uplink signal, which is transmitted by the antenna 935 to the access point 905.

At access point 905, the uplink signal from terminal 930 is received by the antenna 925 and processed by a receiver unit 975 to obtain samples. A symbol demodulator 980 then processes the samples and provides received pilot symbols and data symbol estimates for the uplink. An RX data processor 985 processes the data symbol estimates to recover the traffic data transmitted by terminal 930. A processor 990 performs channel estimation for each active terminal transmitting on the uplink. Multiple terminals may transmit pilot concurrently on the uplink on their respective assigned sets of pilot subbands, where the pilot subband sets may be interlaced.

Processor 990 and 950 direct (e.g., control, coordinates, manage, etc.) operation at access point 905 and terminal 930, respectively. Respective processors 990 and 950 can be associated with memory units (not shown) that store program codes and data. Processors 990 and 950 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used for channel estimation may be implemented within one or more application specific integrated circuits (ASICs), digital signal processors (DPSs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors 990 and 950.

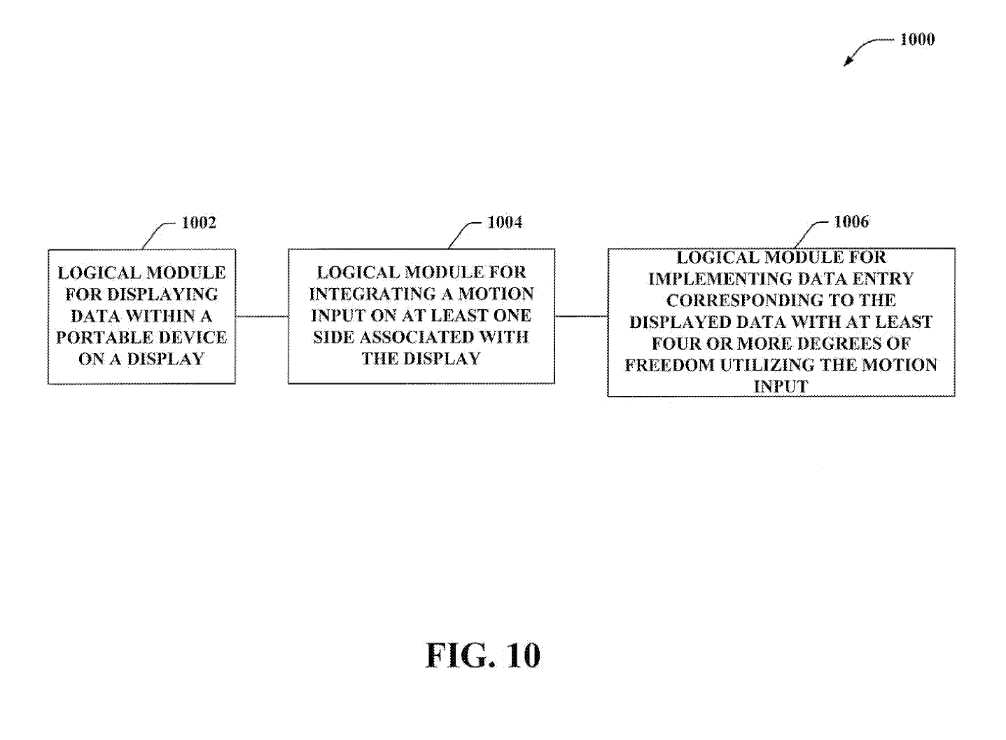

FIG. 10 is an illustration of a system 1000 that facilitates employing four or more degrees of freedom related to data entry for a portable device. A logical module for displaying data within a portable device on a display is illustrated at 1002. A logical module for integrating a motion input on at least one side associated with the display is illustrated at 1004. A logical module for implementing data entry corresponding to the displayed data with at least four or more degrees of freedom utilizing the motion input is illustrated at 1006.

What has been described above includes examples of one or more embodiments. It is, of course, not possible to describe every conceivable combination of components or methodologies for purposes of describing the aforementioned embodiments, but one or ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extend that the term “includes” is used in either the detailed description or the claims, such term is intended to be inclusive in a manner similar to the term “comprising” as “comprising” is interpreted when employed as a transitional word in a claim.

What is claimed is:

1. A method that facilitates data entry, comprising:
incorporating a motion input on at least one side of a portable device, the portable device includes a casing with a front, a back, and at least two sides associated therewith, a top and a bottom; and
utilizing the motion input to employ four or more degrees of freedom for data entry.

2. The method of claim 1, the portable device is at least one of a cellular phone, a smartphone, a text messenger, a hand-held device, a mini-computer, a portable digital assistant (PDA), a hand-held computing device, a satellite radio, a satellite device, a global positioning system (GPS), a GPS device, a device that receives an input for data manipulation, a device that receives an input for data navigation, and a device that can receive data via an input.

3. The method of claim 1, the motion input is at least one of a trackball, a roller-ball, a touchpad, a motion-detection device, and a device that can detect data associated with motion.

4. The method of claim 1, the casing includes an aperture on at least one side, the motion input is embedded within the aperture.

5. The method of claim 4, the motion input is a spherical object with at least a portion of such spherical object protruding from the aperture to allow contact with a digit associated with a user for motion detection.

6. The method of claim 4, the motion input is a touchpad that is flush with at least one side of the portable device.

7. The method of claim 4, the casing is made from at least one of a portion of plastic, a portion of aluminum, a portion of magnesium, and a portion of metal.

8. The method of claim 1, further comprising providing N degrees of freedom with the motion input, where N is a positive integer.

9. The method of claim 1, further comprising utilizing a display on the front of the portable device to display at least a portion of a graphic.

10. The method of claim 1, the motion input is positioned to coincide with a digit on a hand upon the holding of the portable device in the palm of such hand.

11. The method of claim 10, the digit is at least one of a finger and a thumb.

12. The method of claim 1, further comprising utilizing the motion input and four or more degrees of freedom for navigation on a display associated with the portable device.

13. The method of claim 1, further comprising implementing at least one of an activation technique and a de-activation technique for the motion input to allow intentional data entry and reduces accidental data entry.

14. The method of claim 13, at least one of the activation technique and the de-activation technique are one of a button, a key, a voice command, a switch, a password, a fingerprint, a double-click, a sequence of inputs, a particular motion utilizing the motion input, and a retinal scan.

15. The method of claim 1, further comprising employing the motion input as a key input functionality.

16. The method of claim 15, the motion input is at least one of a roller-ball, and a trackball that is depressed into the side of the portable device to provide the key input functionality.

17. The method of claim 1, the motion input is a touchpad that detects a motion substantially similar to depressing a button with a digit to provide the key input functionality.

18. A portable apparatus, comprising:
a memory that retains instructions related to coordinating data associated with a motion input for navigation on a display, the motion input is integrated within the portable apparatus on at least one side interconnected between a back and a front related thereto; and
a processor that evaluates the instructions to utilize data associated with the motion input.

19. The portable apparatus of claim 18, the memory further retains information related to with at least one of the motion input, a touchpad motion input, and data collected via the motion input.

20. The portable apparatus of claim 18, the motion input is at least one of a trackball, a roller-ball, a touchpad, a motion-detection device, and a device that can detect data associated with motion.

21. The portable apparatus of claim 18, the motion input employs N degrees of freedom, where N is a positive integer.

22. The portable apparatus of claim 18, further comprising a display that displays at least a portion of a graphic that relates to the navigation provided by the motion input.

23. The portable apparatus of claim 18, the motion input is a touchpad that detects a motion substantially similar to depressing a button with a digit to provide the key input functionality.

24. The portable apparatus of claim 18, the motion input is at least one of a roller ball, and a trackball that is depressed into the side of the portable device to provide the key input functionality.

25. A portable apparatus that facilitates data navigation, comprising:
means for displaying data within a portable device on a display, the display is enclosed within a casing associated with the portable device;
means for integrating a motion input on at least one side associated with the portable device; and
means for implementing data entry corresponding to the displayed data with at least four or more degrees of freedom utilizing the motion input.

26. The portable apparatus of claim 25, the portable apparatus is at least one of a cellular phone, a smartphone, a text messenger, a hand-held device, a mini-computer, a portable digital assistant (PDA), a hand-held computing device, a satellite radio, a satellite device, a global positioning system (GPS), a GPS device, a device that receives an input for data manipulation, a device that receives an input for data navigation, and a device that can receive data via an input.

27. The portable apparatus of claim 25, the motion input is at least one of a trackball, a roller-ball, a touchpad, a motion-detection device, and a device that can detect data associated with motion.

28. The portable apparatus of claim 25, the casing includes an aperture on at least one side, the motion input is embedded within the aperture.

29. The portable apparatus of claim 25, further comprising providing N degrees of freedom with the motion input, where N is a positive integer.

30. The portable apparatus of claim 25, the motion input is positioned to coincide with a digit on a hand upon the holding of the portable device in the palm of such hand.

31. The portable apparatus of claim 25, further comprising implementing at least one of an activation technique and a de-activation technique for the motion input to allow intentional data entry and reduces accidental data entry.

32. The portable apparatus of claim 31, at least one of the activation technique and the de-activation technique are one of a button, a key, a voice command, a switch, a password, a fingerprint, a double-click, a sequence of inputs, a particular motion utilizing the motion input, and a retinal scan.

33. The portable apparatus of claim 25, further comprising employing the motion input as a key input functionality.

34. The portable apparatus of claim 33, the motion input is at least one of a roller balls, and a trackball that is depressed into the side of the portable apparatus to provide the key input functionality.

35. The portable apparatus of claim 33, the motion input is a touchpad that detects motion substantially similar to depressing a button with a digit to provide the key input functionality.

36. A machine-readable medium having stored thereon machine-executable instructions for:
collecting motion data from a motion input incorporated on at least one side associated with a portable device, the portable device includes a front, a back, at least two sides associated therewith, a top, and a bottom; and
utilizing the motion input to employ four or more degrees of freedom for data entry related to the portable device.

37. The machine-readable medium of claim 36, the portable device is at least one of a cellular phone, a smartphone, a text messenger, a hand-held device, a mini-computer, a portable digital assistant (PDA), a hand-held computing device, a satellite radio, a satellite device, a global positioning system (GPS), a GPS device, a device that receives an input for data manipulation, a device that receives an input for data navigation, and a device that can receive data via an input.

38. The machine-readable medium of claim 36, the motion input is at least one of a trackball, a roller-ball, a touchpad, a motion-detection device, and a device that can detect data associated with motion.

39. The machine-readable medium of claim 36, the at least one side includes an aperture, the motion input is embedded within the aperture.

40. The machine-readable medium of claim 36, further comprising providing N degrees of freedom with the motion input, where N is a positive integer.

41. The machine-readable medium of claim 36, the motion input is positioned to coincide with a digit on a hand upon the holding of the portable device in the palm of such hand.

42. The machine-readable medium of claim 36, further comprising implementing at least one of an activation technique and a de-activation technique for the motion input to allow intentional data entry and reduces accidental data entry.

43. The machine-readable medium of claim 42, at least one of the activation technique and the de-activation technique are one of a button, a key, a voice command, a switch, a password, a fingerprint, a double-click, a sequence of inputs, a particular motion utilizing the motion input, and a retinal scan.

44. The machine-readable medium of claim 36, further comprising employing the motion input as a key input functionality.

45. The machine-readable medium of claim 44, the motion input is at least one of a roller ball, and a trackball that is depressed into the side of the portable apparatus to provide the key input functionality.

46. The machine-readable medium of claim 44, the motion input is a touchpad that detects motion substantially similar to depressing a button with a digit to provide the key input functionality.

47. A processor that executes the following instructions:
displaying data within a portable device on a front portion of the portable device;
collecting motion data from a motion input on at least one side associated with the portable, the motion input employs four or more degrees of freedom; and
utilizing motion data to manipulate the displayed data.
